(19) United States
(12) Patent Application Publication
(10) Pub. No.: US 2026/0149989 A1
(43) Pub. Date: May 28, 2026

(54) System and Method for Detecting Non-Subscription Security Cameras

(71) Applicant: The Board of Regents of the University of Oklahoma, Norman, OK (US)

(72) Inventors: Song Fang, Norman, OK (US); Yan He, Edmond, OK (US); Qiuye He, Lees Summit, MO (US)

(21) Appl. No.: 19/372,015

(22) Filed: Oct. 28, 2025

Related U.S. Application Data
(60) Provisional application No. 63/712,854, filed on Oct. 28, 2024.

(51) Int. Cl. H04W 24/08; G06F 18/214; H04L 69/22; H04N 7/18

(52) U.S. Cl. CPC H04W 24/08; G06F 18/214; H04L 69/22; H04N 7/181

(57) ABSTRACT

A method comprises: performing stimulus-response activation by causing first motion; collecting wireless traffic flows; performing traffic winnowing by marking at least one candidate traffic flow of the traffic flows based on each of the at least one candidate traffic flow having a distinguishable traffic pattern; performing MAC extraction on each of the at least one candidate traffic flow to obtain at least one OUI; performing OUI matching by matching a first OUI of the at least one OUI to a known wireless camera vendor; determining a first traffic flow that is of the at least one candidate traffic flow and that contains the first OUI; performing motion stimulation by causing second motion; performing traffic monitoring of the first traffic; performing feature extraction on the target packets to obtain target data; and inputting the target data into a trained classifier to obtain a camera state of a target wireless camera.

### CROSS-REFERENCE TO RELATED APPLICATIONS

This claims priority to U.S. Prov. Patent App. No. 63/712,854 filed on Oct. 28, 2024, which is incorporated by reference.

### STATEMENT REGARDING FEDERALLY SPONSORED RESEARCH OR DEVELOPMENT

This invention was made with government support under National Science Foundation Grants 1948547 and No. 2155181. The government has certain rights in the invention.

### BACKGROUND

According to the latest report published by Allied Market Research, the global wireless security camera market size was valued at 5.91 billion in 2020 and is expected to reach 18.3 billion by 2030, expanding at a mean annual growth rate of 12.4%. Wireless security cameras can act as behavioral deterrents to inhibit trespassing, intrusion, theft, vandalism, and related forms of harmful activity, and also document what happened as evidence, especially incidents of crimes (e.g., burglary, vehicle prowl, or home invasion). Wireless security cameras are usually triggered by motion, and a few cameras (with a built-in microphone or audio line-in), can also be triggered by sound. Sound-triggered systems, however, often suffer from high false alarms via car engine sounds, barking dogs, or other noises. In this study, we focus on inferring the states of motion-activated wireless cameras.

Non-subscription cameras often have limited features such as live video streaming and motion notifications, rather than cloud recordings which allow users to save captured videos on their online storage. Almost all wireless camera companies offer video-storage plans for customers to purchase. Compared with traditional one-time revenue from the hardware sale, recurring revenue from the sale of subscription plans is predictable, sustainable, and potentially more profitable. The subscription cost normally varies with the video resolution and the number of cameras supported. For example, Arlo offers two options for multiple cameras at a single home and on the same account, $9.99 and $14.99 per month enabling recording in up to 2K and 4K video resolution, respectively. The seemingly small monthly charges, however, add up, and may result in more personal debt. They may thus inevitably impose a financial burden on many users. According to Arlo, it has 5.82 million registered accounts and 877 thousand paid accounts, as of January 2022, meaning that as high as 85% of users still use cameras without a subscription.

Wireless security cameras are often battery-powered, and most of them (e.g., Blink Outdoor) employ motion sensors to conserve battery, by only waking up when motion is detected. There are different types of motion sensors, including PIR, ultrasonic, microwave, tomographic, and combined types. Of these, PIR sensors are most prevalent, being small in size, cheap, and highly sensitive to motion. These are made of a pyroelectric film material sensitive to radiated heat power fluctuation. This material generates electric signals when exposed to heat in the form of infrared radiation. Thus, PIR sensors can detect the presence of humans or other warm-blooded living beings from the radiation of their body heat, meaning that they can work even in the dark.

Wireless security cameras are increasingly affordable, easy to install, and multi-functional (e.g., instantly alerting the camera owner to the presence of intruders and enabling the owner to converse with visitors). They have become an essential tool in a property protection kit, as they can help with the intrusion detection and the recovery of stolen items via video footage. In 2019, there were an estimated 1.12 million burglaries (i.e., the unlawful entry of a structure to commit a felony or theft) in the US, and victims suffered an estimated 3.0 billion US dollars in property losses, according to a report released by the FBI. Meanwhile, the COVID-19 pandemic, which has changed how we interact with the outside world, has also expedited the integration of wireless security cameras into home security, since homeowners can easily use them to check and communicate with delivery persons without coming into physical contact with them.

Beyond the initial investment to buy the hardware, most wireless camera manufacturers offer consumers a paid plan to obtain more services, and offer limited functions for free users, so that users are motivated to pay for more services. Usually, wireless cameras are equipped with motion sensors or microphones for enhanced protection, so that once motion or sound is detected, the camera is activated. The following behavior after the activation, however, often depends on whether the camera has an active subscription plan, which charges for services such as recording or cloud storage. For example, the latest Arlo cameras (e.g., Arlo Pro 3/4) do not actively record when events happen within their fields of view without a paid plan, and users can only get event alerts or manually stream footage to their smartphones via the Arlo app.

Cameras without paid subscriptions may suffer privacy issues, which have not been exploited before. We conducted a survey involving 220 participants: 213 of them believe the unpaid cameras can be used securely without privacy leakage; all users think the manufacturer guarantees that the system security is consistent across devices regardless of their subscription statuses. It is widely known that how owners safeguard their properties plays an important role when burglars select targets. A previous study revealed that in a panel made up of participants convicted of burglary, 13 out of 15 stated that they were not deterred by cameras that they believed were not constantly monitored. Similarly, if the knowledge is available, a burglar or other malicious user will likely first target properties whose cameras do not actively record and save videos.

FIG. 1 provides an example for illustrating the behavioral differences between cameras with and without an active subscription when they are triggered by a continuous movement. Wireless cameras are usually in sleep/standby mode until motion is detected. FIG. 1(A) shows how a wireless camera (Arlo Pro 3) without a subscription only sends a push notification about the event and then quickly returns to sleep mode. The network traffic correspondingly exhibits a short burst when an individual enters the motion detection range of the camera, and returns to normal after that. In contrast, FIG. 1(B) depicts the case when the camera has an active subscription. In addition to sending a push notification, the camera also records and uploads video to the cloud, which the owner can access later, until motion ceases within the detection range. The push notification content sent by a camera with a subscription is also richer than that sent by a camera without a subscription, including a still image from the event. Finally, the camera reverts to sleep mode. Corresponding to this activity, there appears a long traffic burst lasting from the moment the person enters to when they leave the motion detection range. Both cases have distinguishably different wireless traffic patterns, which can be in turn utilized to infer the camera's subscription status.

In contrast to this immediate recording and upload, owners receiving push notifications via smartphones may or may not respond quickly or at all. As motion alerts are sometimes inaccurate or irrelevant, some users may disable notifications or become desensitized to them. Generally, if they turn on the live view mode, the resultant live streaming will make the camera generate more traffic until the live view mode is turned off. Such a traffic burst may be confused with the one caused by the automatic cloud recording of a camera with a subscription. Nevertheless, a human cannot initiate the video processing module instantly when a push notification is received, as there are two non-negligible delays: (1) the user needs to first access the phone and tap the camera app, depending on the user's response time; and (2) the app needs time to be launched. However, a subscribed camera can almost instantly begin cloud recording once it detects motion and sends the push notification. Consequently, the live mode and cloud recordings have different impacts on the traffic generation of the camera, and the resultant traffic pattern dissimilarity provides a clue to distinguish them.

### BRIEF DESCRIPTION OF THE DRAWINGS

Several embodiments of the present disclosure are hereby illustrated in the appended drawings. It is to be noted however, that the appended drawings only illustrate several typical embodiments and are therefore not intended to be considered limiting of the scope of the present disclosure. Further, in the appended drawings, like or identical reference numerals or letters may be used to identify common or similar elements and not all such elements may be so numbered. The figures are not necessarily to scale and certain features and certain views of the figures may be shown as exaggerated in scale or in schematic in the interest of clarity and conciseness.

FIG. 1 is a schematic showing (A) a camera with a subscription and (B) a camera without a subscription.

FIG. 2 shows the two-phase process (training and inference) used by the disclosed system to infer camera states from observed wireless traffic: (A) the Training Phase used to build a traffic classifier, and (B) the Inference Phase used to recognize traffic modes.

FIG. 3 shows comparisons of success rates.

FIG. 4 shows comparisons of F1 scores.

FIG. 5 shows variation in traffic volumes.

FIG. 6 shows a MAC frame format and a source address example.

FIG. 7 shows SVM classification results.

FIG. 8 shows the impact of motion duration.

FIG. 9 shows the impact of live view duration

FIG. 10 shows the layouts of the indoor and outdoor environments.

FIG. 11 shows traffic volume V (pkts) changes.

FIG. 12 shows the impact of motion duration.

FIG. 13 shows F1 scores vs. motion duration.

FIG. 14 shows average success rates.

FIG. 15 shows F1 scores of different cameras.

FIG. 16 shows the impact of movement speed.

FIG. 17 shows F1 scores vs. speed.

FIG. 18 shows the accuracy for new cameras

FIG. 19 shows the time spent for new cameras.

FIG. 20 shows indoor success rates.

FIG. 21 shows outdoor success rates.

FIG. 22 shows overall confusion matrixes.

FIG. 23 shows CDFs of detection time.

FIG. 24 shows individual success rates.

FIG. 25 shows individual F1 scores.

FIG. 26 shows individual detection times.

FIG. 27 shows a UI snapshot for the app.

FIG. 28 shows a non-limiting embodiment of the presently disclosed external tool for WiFi sniffing.

FIG. 29 is a schematic diagram of an apparatus.

FIG. 30 is a flowchart of a method of detecting non-subscription security cameras.

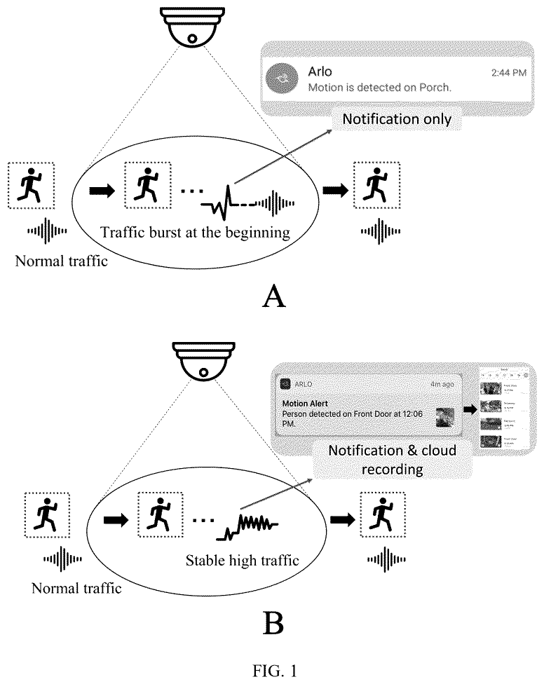

### DETAILED DESCRIPTION

Wireless security cameras are utilized to identify and deter intruders. Accompanying the hardware, consumers optionally pay recurring monthly fees for recording videos to the cloud, or use the free tier offering motion alerts and sometimes live streams via the camera app. Many users purchase the hardware without buying the subscription to save money (“non-subscription cameras”), which inherently reduces their efficacy. We discovered that the wireless traffic generated by a camera responding to stimulating motion may disclose whether or not video is being streamed. A malicious user such as a burglar may use such knowledge to target homes with a “weak camera” that does not upload video or turn on live view mode. In such cases, intrusion would not be recorded though performed within the monitoring area of the camera. Described herein is a novel system and method called WeakCamID that creates motion stimuli and sniffs resultant wireless traffic to infer the camera state. A survey involving a total of 220 users found that users think cameras have a consistent security guarantee regardless of the subscription status. The present work proves such dogma wrong. Herein we have implemented a novel system referred to herein as WeakCamID in a mobile app and experimented with 11 popular wireless cameras to show that WeakCamID can identify weak cameras with a mean accuracy of around 95% and within less than 19 seconds. The present work shows that using such non-subscription cameras is not as safe as using versions with a paid subscription and may cause significant privacy concerns.

Before further describing various embodiments of the apparatus, component parts, and methods of the present disclosure in more detail by way of exemplary description, examples, and results, it is to be understood that the embodiments of the present disclosure are not limited in application to the details of apparatus, component parts, and methods as set forth in the following description. The embodiments of the apparatus, component parts, and methods of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus, component parts, and methods of the present disclosure have been described in terms of particular embodiments, it will be apparent to those of skill in the art that variations may be applied to the apparatus, component parts, and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference herein in its entirety to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms and phrases, unless otherwise indicated, shall be understood to have the following meanings: The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The phrase “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the apparatus, composition, or the methods or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, percentage, temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 75% of the time, or at least 80% of the time, or at least 85% of the time, or at least 90% of the time, or at least 91%, or at least 92%, or at least 93%, or at least 94%, or at least 95%, or at least 96%, or at least 97%, or at least 98%, or at least 99%, of the time, or means that the dimension or measurement is within at least 75%, or at least 80%, or at least 85%, or at least 90%, or at least 91%, or at least 92%, or at least 93%, or at least 94%, or at least 95%, or at least 96%, or at least 97%, or at least 98%, or at least 99%, of the referenced dimension or measurement (e.g., length). Alternatively, “substantially” means within or beyond 1%, 5%, 10%, or another suitable metric depending on the context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5.

As used herein any reference to “we” as a pronoun may include laboratory personnel or other contributors who assisted in the laboratory procedures and data collection and is not intended to represent an inventorship role by said laboratory personnel or other contributors in any subject matter disclosed herein.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

The following abbreviations apply:
ASIC: application-specific integrated circuit
BLE: Bluetooth Low Energy
CDF: cumulative distribution function
CPU: central processing unit
DSP: digital signal processor
DT: decision tree
EO: electrical-to-optical
FBI: Federal Bureau of Investigation
FCS: frame check sequence
FPGA: field-programmable gate array
GPIO: general-purpose input/output
GPU: graphics processing unit
HLS: HTTP Live Streaming
IoT: internet of things
IP: Internet Protocol
MAC: medium access control
MCU: microcontroller unit
m/s: meter(s) per second
NIC: network interface card
OE: optical-to-electrical
OUI: organizationally-unique identifier
PIR: passive infrared
RAM: random-access memory
RF: radio frequency
ROM: read-only memory
RX: receiver unit
SoC: system on a chip
SRAM: static RAM
SVM: support vector machine
TCAM: ternary content-addressable memory
TI: Texas Instruments
TX: transmitter unit
UI: user interface
UUID-E: universally-unique identifier-enrollee.

Returning now to the description of several embodiments of the disclosure, WeakCamID is a framework able to distinguish the state of a wireless camera, that is, whether or not the camera has a subscription or is “non-subscription” and if its live view mode is turned on. Such an inference attack is non-trivial due to the following reasons. (1) The attacker cannot directly extract the traffic flow for the target camera, as it has neither control over the environment nor access to the WiFi network that the camera is connected to. The environment also likely contains many wireless devices and has a mixture of all flows from various devices, such as laptops, smartphones, or tablets. (2) To the best of our knowledge, previous extensive research efforts in detecting/localizing wireless cameras all assumed that the cameras have the capability of recording the motion events without further distinction regarding the camera's subscription status. The existing course-grained traffic pattern identification methods can identify the existence of a camera while we cannot apply them to infer the subscription status. A novel and fine-grained traffic pattern technique is thus required. (3) Live streaming, relying on user operation, may generate comparable wireless traffic to cloud recording. Existing research either considers continuous/confirmed live streaming or simply ignores it. To determine whether live streaming is on or off, human behavior then needs to be considered. (4) Traditional all-channel WiFi sniffing often requires rooted Android phones, limiting its practicality. Such an engineering challenge should also be overcome.

Almost all commodity wireless devices utilize 802.11 wireless protocols, and their use has an inherent weakness: exposure of link-layer MAC addresses. A passive adversary within the radio range of a wireless camera can extract its MAC address, which tells the information of its device manufacturer via the beginning three most significant MAC bytes, i.e., the OUI. WeakCamID first utilizes the motion-traffic correlation phenomenon to determine possible candidates of traffic flows belonging to a target camera, and then cross-references OUIs with publicly available manufacturer information to figure out the final candidate. By feeding motion stimuli to the camera and sniffing resultant traffic that varies with the camera state, WeakCamID builds a model to correlate motion-induced traffic with camera state. Such a model can be then used to map observed un-labelled traffic flows into corresponding camera states.

With WeakCamID, we discovered that it could be counterproductive to install non-subscription wireless security cameras. The service differentiation between paying and non-paying users does not just create inequality in degrees of protection. The function restriction for non-paying users in fact introduces a serious vulnerability, which an adversary could take advantage of to identify properties with “weak” cameras. With a non-subscription camera, if the property owner does not view live streams in time, the events occurring in the area monitored by the camera will not be recorded. In such scenarios, as eye-witness descriptions and filmed recordings are not available, malicious users may perform inappropriate or criminal activities without worrying about being identified or leaving traces.

Several contributions of the present technology are summarized as follows:
(1) We point out the vulnerability of current wireless security cameras in differentiating services for paying and nonpaying users and develop the first practical tool to successfully infer different camera states.
(2) We systematically explore the correlation between motion stimuli with the resultant wireless traffic generated by cameras with varying subscription statuses.
(3) We show that WeakCamID can detect user response to motion alerts by distinguishing high traffic volumes caused by cloud recording and live streaming.
(4) We develop an app for validating the effectiveness and efficiency of WeakCamID. Experimental results show that WeakCamID can attain a mean success rate of 95% to infer camera states within 19 seconds.

### Attack Model and Assumptions

We considered a general scenario, where a wireless security camera is deployed to monitor a target area with an unknown subscription status. Once motion is detected in the camera's range, a camera without a subscription only sends a push notification to the owner, while a camera with an active subscription also enables cloud recording. After receiving push notifications about motion events, the owner may or may not turn on the live view mode of the camera through the camera app. The adversary aims to employ WeakCamID to infer the camera state, i.e., whether the camera has a subscription and whether the live stream is opened.

We assumed that the adversary has the capability to sniff wireless traffic and perform some probing motion in the target area. To avoid being exposed, the adversary can actively employ a helper or some moving robot (e.g., drone/robot/car) that emits heat to introduce movement. Additionally, they can passively monitor camera activity and rely on others triggering motion sensing. Note that it is not necessary for the attacker to know the exact location of the camera. In a common scenario, people often make wireless security cameras visible with the hope of deterring malicious users. For example, owners may post signs and stickers to warn that there is a security camera present. Such visibility, however, could help the adversary quickly determine the possible motion detection range of the camera. On the contrary, when the camera is hidden, WeakCamID still works, as it can recognize the existence of wireless cameras by analyzing motion-induced wireless traffic. After the attacker confirms that the camera has no subscription and no live video is turned on, she may bypass it to perform further malicious activities (e.g., burglary and intrusion) without being recorded.

### Camera State Inference

### 1.1 Framework Overview

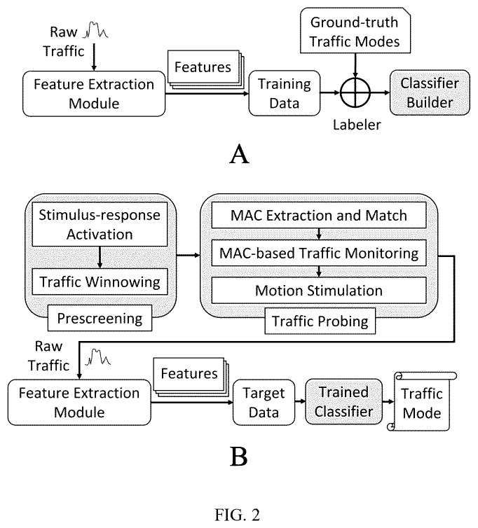

WeakCamID) performs a two-phase process to infer camera states from observed wireless traffic: the training and inference phases. FIG. 2 plots an overview of this process. FIG. 2(A) depicts the offline training phase, in which a traffic classifier is built with the motion-induced traffic data collected from sample wireless security cameras and their corresponding states. The inference phase then uses the trained traffic classifier to recognize new traffic flows, as shown in FIG. 2(B). As aforementioned, there may be a variety of devices sending out wireless traffic in a new environment. Thus, in the inference phase, the adversary must first identify the traffic flow associated with the specific target camera. Toward the goals, WeakCamID introduces two important phases before extracting traffic features, which are traffic prescreening and traffic probing.

The first phase coarsely determines the wireless traffic flow associated with the target camera. When provoking motion within a target area, if there is a wireless camera monitoring this area, a corresponding wireless traffic burst will be immediately observed as the triggered camera generates traffic. The burst can be short or long depending on the camera's subscription status. The traffic flow exhibiting such a distinguishable pattern is regarded as a candidate.

In the second phase, we further eliminate the inference of other wireless devices which coincidently exhibit traffic patterns similar to the target camera in the first phase. We inspect the OUI in the MAC address embedded in each candidate traffic flow to sort out the camera-generated traffic flow and then monitor the surviving traffic. We then feed manipulated motion to the camera in order to extract features from the resultant traffic.

### 1.2 Training Phase

Our model is trained via data collection, feature extraction, state labeling, and traffic classifier building steps.

### Data Collection:

To capture raw wireless packets originating from the camera, we should know the channels that the camera operates on. The wireless NIC of a traffic sniffing device needs to be in monitor mode to listen to all the wireless traffic nearby. Generally, the monitor mode is disabled, and the default/normal mode of an NIC is managed mode, which makes the device only capture packets with its own MAC address as the destination MAC and discard other packets.

Sniffing with Laptop: An intuitive way to achieve traffic sniffing is to use network sniffing software such as WireShark, but this method requires the sniffer to be able to access the same WiFi network as the target camera. The network is often secured with a password, which is unknown to the sniffer. Alternatively, if the laptop has a compatible wireless network adapter (e.g., Intel 622AN) that supports monitor mode, the Aircrack toolkit, which is open source, can be then utilized to enable monitor mode.

Sniffing with Android Phone: A laptop may be bulky for a user to carry. To enable monitor mode on an Android phone, we need first to perform kernel live patching corresponding to the phone model and then employ Airmon-ng tool, which is included in the Aircrack-ng package. For example, we enable the monitor mode on a Nexus 5 Android phone by using Nexmon to patch the phone's kernel and then can run WeakCamID on the rooted Nexus 5. Finally, the collected traffic data are loaded into the SQLite database for feature selection.

### Feature Extraction:

Different camera states usually lead to different spatiotemporal patterns in collected wireless traffic data. We then extract relevant features to construct our “feature vector” and use it to train the model.

Normally, when we continuously feed motion stimuli to a wireless camera for a period (e.g. 10 seconds), the camera experiences multiple phases. First, the camera sends an event notification to the owner, causing the first traffic burst. Second, the camera may or may not start recording the activity, depending on whether the camera has a subscription (i.e., cloud recording capability). If the camera has a subscription, it will immediately start to record the activity and upload the captured video to the cloud backend. As a result, another traffic burst will be generated, which is often larger than the one appearing in the first phase. However, if the camera has no subscription, the camera will not record the activity, and the traffic volume will soon become zero after sending the event notification to the property owner. Finally, the traffic flow varies according to the action taken by the property owner after she or he receives the event notification, i.e., whether to enable the live video by opening the app associated with the camera. Specifically, if the owner quickly presses the push notification after receiving it and then opens the camera app to watch the live streaming video from the camera, the traffic throughput (i.e., the rate at which the wireless camera generates packets) will abruptly increase again. Accordingly, we refer to these three phases as event notification, camera response, and user operation, respectively. We then extract features unique to the camera state to characterize each phase.

Phase 1—Event Notification: When motion is detected, a camera with a paid subscription (e.g., Arlo camera) often generates a rich push notification, attaching a thumbnail image of the event to the event notification, while a non-subscription camera only sends the basic event notification. Thus, the corresponding peaks of the instant traffic throughput will differ. We define the period of this phase as from the beginning of the first observable traffic peak to the next one for paid cameras (as they start to record and upload the recorded video to the cloud), and back to 0 for unpaid cameras. Accordingly, we record two features, the peak traffic throughput

$${T}_{1}^{p} ,$$

and the mean value T̅₁ for the period of this phase.

Phase II—Camera Response: Paid cameras also perform cloud recording except for event notifications, while unpaid cameras do not and stay silent without being triggered. We regard the point from which the traffic abruptly increases or decreases as the ending point of the second phase for paid cameras; the abrupt traffic change is determined by whether the live streaming is enabled or not. A user may not always respond to a notification, e.g., when they are busy or sleeping, while if the user chooses to turn on live video streaming, it needs some time, and this delay includes two parts: (1) the interval between the time when the user receives the event notification and the time when the user opens the app, and (2) the time that the app needs to load. Empirically, this delay is at least 3 seconds. For unpaid cameras, we just consider the period of the second phase as 3 seconds, and such a period is enough to characterize how unpaid cameras respond to motion after event notification. Similarly, we record the peak traffic throughout

$${T}_{2}^{p}$$

and the mean traffic throughput value T̅₂ in the second phase. Obviously, for unpaid cameras, we have T₂^{p}=T̅₂≈0.

Phase III—User Operation: This phase happens only when the user turns on live view mode. For paid cameras in normal mode (i.e., no live view is enabled), the generated traffic will be nearly stable until the motion ends, while in live view mode, such traffic becomes a combination of recording and streaming traffic and would thus be higher. Also, after the motion ends, there will be only streaming traffic until the user turns the live view mode off. For unpaid cameras, no recording happens in normal mode and thus no traffic is generated for it, while they are re-triggered to generate the streaming traffic in live view mode and revert to standby mode once the user closes the live view mode. We specify the third phase starting from when traffic burst appears after the second phase until when the camera enters standby mode. Likewise, we mark the corresponding peak traffic throughput

$${T}_{3}^{p}$$

and the mean value T̅₃ for this phase. If no live view is enabled, we set T₃^{p}=T̅₃≈0.

A camera's state has four possibilities, live view mode and normal mode (i.e., when live view is unopened), with and without a subscription accordingly. We refer to the four states as Paid—Live View, Paid—Normal, Unpaid—Live View, and Unpaid—Normal. The final feature-vector corresponding to the resultant wireless traffic when introducing motion stimuli to a wireless camera with one state (Sᵢ, i∈{1,2,3,4}) thus can be denoted with a 6-element vector, i.e.,

$$FV ( {S}_{i} ) = [ {T}_{1}^{p} , {\overline{T}}_{1} , {T}_{2}^{p} , {\overline{T}}_{2} , {T}_{3}^{p} , {\overline{T}}_{3} ] .$$

Impact of User Behavior: We do not assume deterministic user behaviors. The owner can make decisions arbitrarily. The success rate thus does not depend on user behavior, and WeakCamID works regardless of whether users respond to notifications. If the live view is off, the inference result would be ‘paid-normal’ or ‘unpaidnormal’; otherwise, it is ‘paid-live view’ or ‘unpaid-live view’.

### State Labeling:

Once the feature vectors are extracted from the sniffed wireless traffic, WeakCamID creates a training set by labeling camera states. The labeled feature vectors can be used to train the classifier in the next step.

Dataset Splitting: We have a dataset containing feature vectors coming from 11 different cameras that we examine for training. We perform different durations of motion from 2 to 16 seconds with increments of 2. For every motion length, we collect 70 corresponding traffic flows for each camera state of every camera, enabling us to obtain high inference accuracy. Thus, the built dataset has 11×8×70×4=24,640 feature vectors in total. We apply the common 80/20 split for training and test sets.

### Traffic Classifier Building:

The last step of the training phase consists of training a model that will be used during the inference phase to infer the camera state accordingly.

We choose a supervised learning (classification) technique over traditional statistical methods for two reasons. First, the wireless traffic flows generated by cameras with different brands/models responding to motion stimuli may be different, as different manufacturers may have proprietary configurations. For example, the patterns of the traffic generated by Ring and Arlo cameras for sending out push notifications are different; a Ring camera only sends a text notification, while an Arlo one also includes a thumbnail event image along with the text notification. It is thus difficult to build a statistical model in the form of mathematical equations to directly correlate the selected features with the camera state. Second, pre-configured video resolution for cameras may also vary across different or even the same brands of cameras. For example, the default resolutions of Arlo Pro and Arlo Ultra Camera Series are 1440p (2560×1440) and 2160 p (3840×2160), respectively, while all Ring cameras share one same video resolution of 1080p (1920×1080). Such configuration variations can cause traditional statistical methods to generate inaccurate results over time as the data set changes. This phenomenon further increases the hurdle for us to construct a universal statistical model. Machine learning methods, however, can analyze amounts of data quickly and identify patterns that are not visible to traditional statistical methods. They can also automatically adapt to changes in the data set, ensuring that the inference can always achieve high accuracy.

With the aforementioned six parameters, we can utilize popular machine learning tools to build inference models, such as tree-based or SVMs. Tree-based methods, e.g., DTs and random forests, build a treelike structure for deciding cameras states according to the selected features, while SVMs find hyperplanes that best separate the traffic features into different domains (i.e., camera states). To build an optimal classifier, we implement and compare the following three algorithms in the scikit-learn environment: DTs, RFs, and SVMs. There are four camera states, and we then use SVMs for multi-class classification. The approach we use is one-versus-one.

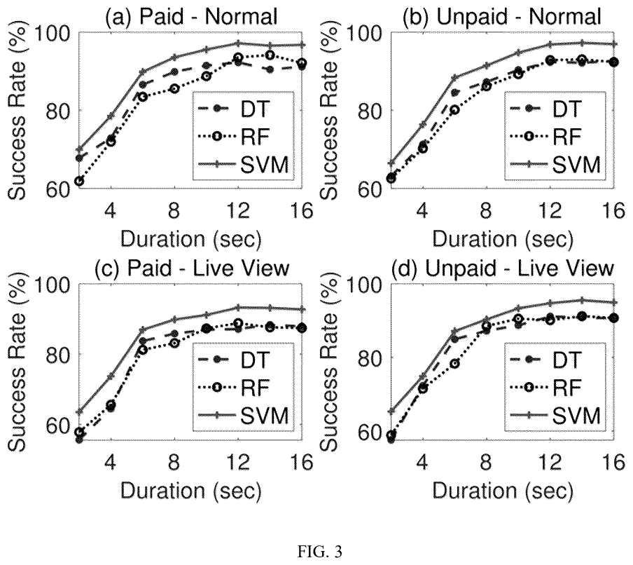

Classifier Selection: Compared with the other two classifiers, we empirically find SVMs achieve better inference performance. FIG. 3 presents the success rates for different classification algorithms applied to the test dataset. The success rate refers to the proportion of correct inference in all inference attempts. We have three key findings. First, the impact of motion duration and classifier algorithm for all four camera states are roughly consistent, and the overall success rates for cameras in the normal state are slightly higher than in the live view mode. Second, the success rates of all three algorithms increase with motion duration from 2 to 12 seconds and maintain relatively stable after the duration reaches 12 seconds. Particularly, when the motion duration is less than 8 seconds, all algorithms have success rates of less than 90%. This appears due to the lack of distinctive features in the traffic flows when the motion just lasts for a short time period. When the motion duration is 12 seconds or longer, all algorithms achieve success rates larger than 90%. In Section 2.3, we further evaluate the impact of motion length of no less than 8 seconds on the inference performance for varying cameras. Lastly, SVM shows the best performance among the three algorithms, and it can achieve success rates of higher than 97% for paying or non-paying cameras in the normal state when the motion duration is 12 seconds.

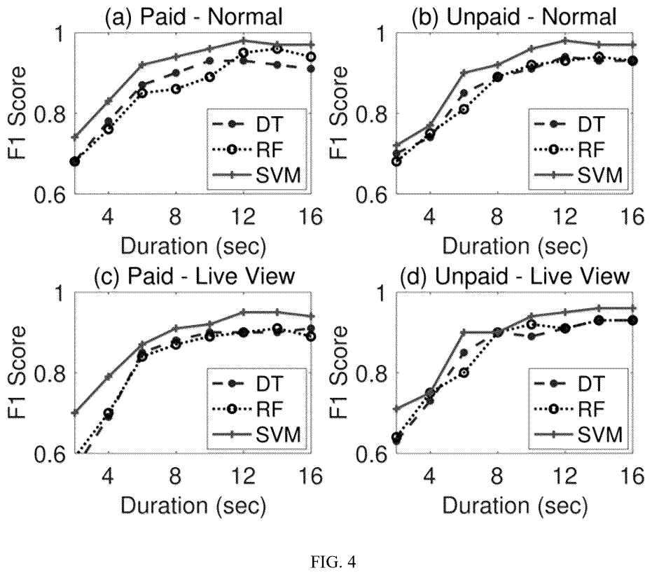

For each camera state, we also count the true positive, false positive, true negative, and false negative cases, referred to as TP, FP, TN, and FN. The corresponding success rate then equals (TP+TN)/(TP+TN+FP+FN). Meanwhile, Precision and Recall of the model can be denoted as TP/(TP+FP), TP/(TP+FN). We further compute F1 score (i.e., 2/(Recall⁻¹+Precision⁻¹), as shown in FIG. 4. Similarly, we see that the SVM always achieves higher F1 scores than the other two algorithms. For normal modes, the SVM obtains an F1 score of as high as 0.98, indicating its outstanding performance in both precision and recall.

### 1.3 Inference Phase

In the inference phase, the adversary needs to first determine that the target camera is a wireless motion-activated camera via two important steps, traffic prescreening and traffic probing. The following processes are performed much in the same way as the training phase has, by attempting to achieve camera state inference through data collection, feature extraction, and traffic classification.

### 1.3.1 Traffic Prescreening.

Over the air, there may exist diverse wireless traffic flows generated by a myriad of IoT devices or applications (such as smart TVs and digital voice assistants). We thus need to first distinguish the traffic flow of the target camera from traffic flows generated by non-camera devices and other wireless cameras deployed in the environment. We propose to generate motion (e.g., walking) within the camera's monitoring area to stimulate it, and then use the resultant wireless traffic to narrow down the candidates for the target traffic flow.

### Stimulus-Response Activation:

Most wireless cameras are powered by rechargeable lithium-ion batteries, either built-in or removable. They normally sit in sleep/standby mode to save power consumption and come awake when (1) motion is detected or (2) the camera is manually turned on to live view. In standby mode, the camera usually just generates a “heartbeat signal” with a small size periodically (i.e., in order of seconds) to notify normal operation of the camera and synchronize with the base station or router.

Upon activation, the camera then sends a push notification of the motion event. If the camera has an active subscription, it also starts to record until motion stops and immediately uploads the video to the cloud for secure storage in the owner's library so that the owner can access them anytime; otherwise, if the camera has no subscription, only a push notification will be sent while no recording is initiated. Accordingly, abnormally high wireless traffic (indicating the push notification) will be generated regardless of the subscription status, and the traffic volume will soon become higher (as recording/uploading starts) for cameras with active subscriptions while decreasing to none (when heartbeat signals are ignored) for cameras with no subscription.

Therefore, to observe wireless traffic generated by the target camera, an adversary can feed the camera with activation signals by performing motion in the motion detection range of the camera.

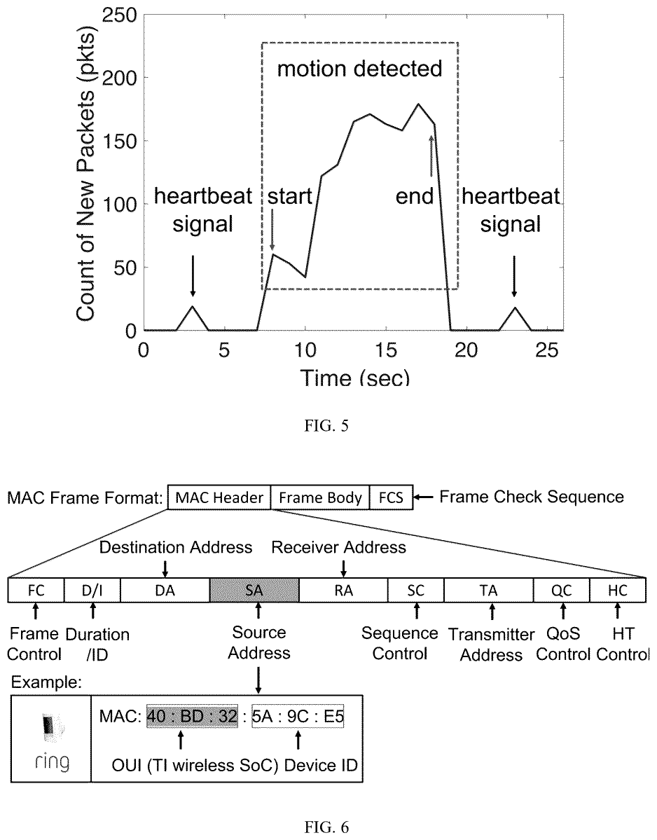

FIG. 5 depicts the traffic flow generated by a wireless camera (Ring Stick Up Cam with an active subscription) when we walk inside the motion detection range of the camera (8˜18 seconds). We observe that when the camera is in sleep mode, it only sends out a heartbeat signal of a small size. When the motion event is detected, the newly generated traffic volume suddenly increases immediately for sending a push notification. Next, as the camera starts to record to the cloud, a larger traffic volume appears until the motion in the motion detection range of the camera disappears. Without motion stimulus, the camera comes back to sleep mode.

### Traffic Winnowing:

For a wireless camera in sleep mode (i.e., when there is no live view or video recording), the corresponding wireless MCU, such as TI CC3220S for a Ring Stick Up Cam, consumes low power and only listens for any trigger source. The motion sensor is integrated with the wireless MCU. Once it detects motion, it toggles the GPIO and generates an interrupt, which wakes up the camera to send a push notification and start cloud recording (if the camera has an active subscription). Consequently, the wireless traffic generated by a wireless camera has a strong correlation with the motion performed in the motion detection range of the camera regardless of the subscription status of the camera. Specifically, when a camera is wakened up by motion, a burst of wireless traffic can be immediately observed.

The distinguishable traffic pattern of the camera enables the adversary to winnow out irrelevant traffic flows, which do not show bursts according to the appearance of the artificial motion. If a monitored wireless traffic flow suddenly jumps with the motion being performed and plummets as the motion stops, we then mark it as a candidate for the traffic flow of the target camera. As the environment may have multiple motion-activated devices including the target camera, one or multiple candidates may be identified.

### 1.3.2 Traffic Probing.

It is essential to determine precisely which traffic flow belongs to the target camera before collecting its traffic features. We utilize the MAC addresses of the devices to pinpoint the traffic flow associated with the target camera from the obtained traffic candidates in the previous step. After that, we set up a listener to monitor the traffic transmitted from the target camera and observe the traffic change on this channel when provoking the camera with manipulated environmental motion.

### MAC Extraction and Match:

A MAC address is a unique identifier assigned to a NIC for every networked device. It consists of 48 bits that are typically represented as 6 pairs of hexadecimal digits separated by colons or dashes. The first half is the OUI, indicating a manufacturer or vendor; the second half refers to the device ID.

As IEEE 802.11 wireless communication (i.e., WiFi) employs security protocols such as WEP, WPA, WPA2, and WPA3, the recorded videos are encrypted in WiFi signals. A general IEEE 802.11 MAC frame consists of a header, body, and FCS, as shown in FIG. 6. The header holds information about the frame; the body carries data that needs to be transmitted; FCS is used for detecting errors during the transmission. However, the header is unencrypted during transmission and exposes the MAC of the device sending the traffic. For example, Ring Stick Up cameras utilize TI's chipset (i.e., CC3220S) for WiFi communication, and the OUI of their MACs starts with “40:BD:32”, which indicates the SoC from the manufacturer TI. The OUIs of different manufacturers are normally public. We can thus build a dataset, referred to camera-tagged OUI database, containing OUIs of known vendors that manufacture wireless cameras.

WeakCamID first extracts the OUI in the MAC of each candidate for the traffic flow belonging to the target camera, and then checks the camera-tagged OUI dataset for a match of this OUI. If present, such a traffic flow is regarded as being generated by a wireless camera. Otherwise, it will be removed from the candidate list.

Dealing With MAC Spoofing: MAC addresses of NICs are hard coded in their circuit at the moment of manufacture. However, they can be changed via MAC randomization or spoofing. A camera may use a forged MAC with an OUI indicating a noncamera manufacturer for masquerading as a non-camera device, and similarly, a non-camera device may use a fake MAC with an OUI showing a camera manufacturer to pretend to be a camera. Since the payloads of raw WiFi packets are encrypted and the network of the target camera is inaccessible to the adversary, traditional traffic flow classification methods using a 5-tuple (source IP and port, destination IP and port, and protocol type) or a 3-tuple (source IP, destination IP, and protocol type) do not apply. However, an attacker can launch the UUID-E reversal attack to retrieve the original MACs for the devices with randomized or spoofed ones, as the UUIDE is derived from a device's original MAC and does not change with MAC. Alternatively, we utilize the wireless traffic pattern characteristics to uniquely identify camera devices.

The SoCs are responsible for video/audio encoding and multimedia data transmission. Thus, the traffic patterns of a wireless camera highly depend on its SoC. However, the SoC choices are limited and most SoCs take largely identical operating flows, causing similar traffic patterns. Particularly, wireless cameras follow universal standards to encode, encapsulate, and deliver video data to the cloud or users' devices. For example, Apple's HLS, the most popular streaming format for the video industry according to an annual survey, requires that all videos must be encoded using H.264/AVC or HEVC/H.265. Accordingly, we train a SVM model by using the Scikit-learn libraries with Python 3.9, to distinguish traffic flows belonging to wireless cameras and non-camera devices.

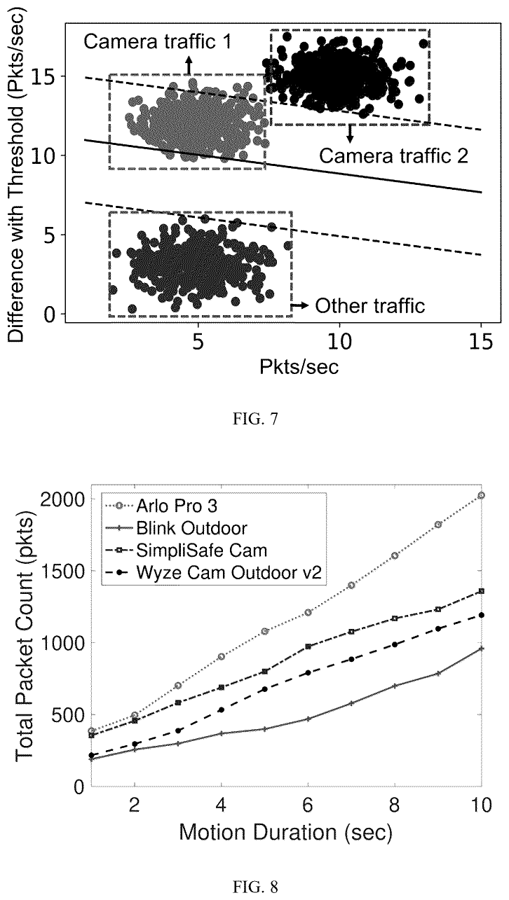

An SVM classifier produces a hyperplane to best separate the input data into two classes. Since the cameras may or may not initiate video recording under different circumstances, the corresponding traffic patterns normally differ vastly. For such a multi-class case, we classify all traffic flows into three classes with the one-versus-one approach. For the cameras with no subscription and with live video mode turned off, they only generate traffic for push notifications and do not record video. We refer to such traffic as Camera traffic 1. For the cameras with subscriptions or with live video mode turned on, they also generate traffic for video recording, and we refer to the corresponding traffic as Camera traffic 2. We call the traffic generated by non-camera devices as Other traffic. We set a threshold according to the average data transmission rate of various wireless devices in the environment. For each traffic flow, we calculate its data transmission rate, as well as the difference between this rate and the threshold. FIG. 7 depicts the outcome of running the created multiclass SVM on a data set containing 800 traffic flows coming from wireless cameras (in different modes and subscription statuses) and non-camera devices, demonstrating the success of identifying traffic flows generated by wireless cameras.

### MAC-Specific Traffic Monitoring:

By setting up a packet monitor with existing tools, we can listen to the traffic coming from the device identified as a camera. Particularly, we detect if the traffic volume varies and record the count change of intercepted packets.

### Motion Stimulation:

The longer we perform motion in the motion detection range of the camera with a subscription, the more (cumulative) packets the camera may generate. We have the same observation for the live view duration. We deploy four different wireless cameras (including Arlo Pro 3, Blink Outdoor, SimpliSafe Cam, and Wyze Cam Outdoor v2) to monitor the activity in an area. We perform two groups of experiments to verify the impact of cloud recording and live view on camera traffic, respectively.

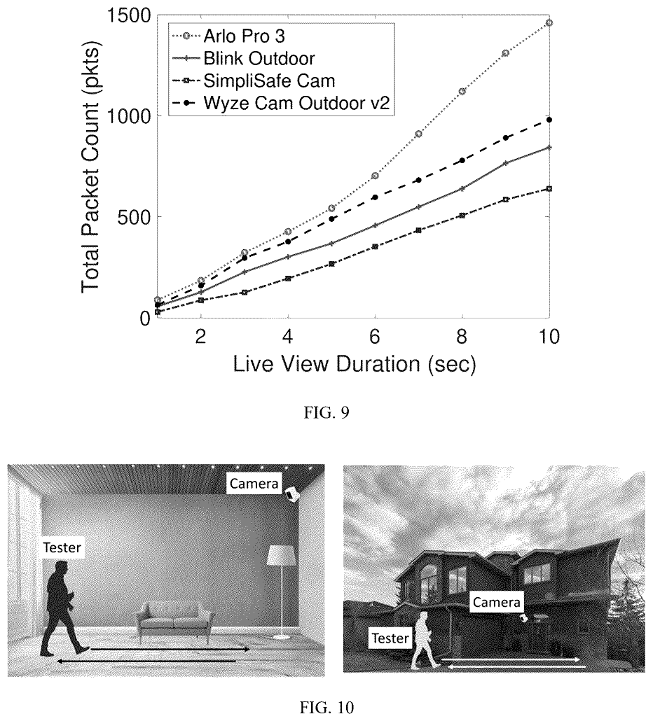

First, each camera has an active subscription and the live view mode is turned off. We collect the traffic packets generated by each camera and count the corresponding total amount of the transmitted packets when a user manually introduces motion within varying durations, as shown in FIG. 8. Second, each camera has no active subscription while the live view mode is turned on for streaming the activity. Similarly, we collect the traffic packets generated by each camera and count the corresponding total amount of the transmitted packets when the live view lasts different durations, as shown in FIG. 9. We see that different cameras present diverse total packet lengths changing with the motion or live view duration, due to various recording or live streaming mechanisms taken by different camera manufacturers. Overall, the obtained total packet count (denoted with T) consistently shows a nearly linear correlation with the duration of both the motion and the live view. For example, for every second, the corresponding packet counts for Arlo Pro 3 to record to the cloud and to stream live videos are around 183 and 156, respectively.

Accordingly, we consider a linear model to describe such as relationship, which is defined as follows,

$$T = c \cdot Δ t + k , \qquad ( 1 )$$

where k is constant, Δt denotes either the motion or live view duration, and c represents the traffic throughput, i.e., the rate at which the camera generates packets.

The model can be then utilized to determine whether the performed motion is still captured by the camera or whether the live view mode is still on. Specifically, if the observed total packet count and the motion or live view duration do not fit the linear model with a significant deviation, the cloud recording or live video streaming will be regarded as ended.

### 1.3.3 Traffic Inference.

The process of traffic inference is defined much in the same way as the training phase by attempting to infer camera states via data collection, feature extraction, and traffic classification. After the traffic of the target camera responding to the motion stimuli is collected, the same features derived during training can be calculated. The obtained feature vector is then inputted into the built classifier, which outputs the camera state.

### Implementation

We implement WeakCamID on commodity user devices.

### 2.1 Experimental Setup

To achieve WiFi sniffing, existing studies usually use rooted Android phones or certain models of laptops (e.g., Macbook Pro), whose NICs can be set to monitor mode. It is burdensome to bring a laptop when performing WeakCamID. Also, smartphone vendors make it increasingly difficult to gain root access. Meanwhile, apps (e.g., Google Pay) can detect root access and refuse to boot up if found. Instead, we design a new portable and low-cost external tool to enable WiFi sniffing, as shown in FIG. 28: a BLE module for a phone connection, a touch screen for user interaction, a WiFi adapter card (e.g., RTL8814AU chipset) in monitor mode, and a Raspberry Pi 4 Model B acting as a platform for the previous three components. This tool can connect with the app via BLE. Our design makes it possible to run WeakCamID on any factory default smartphone without rooting it.

The app first scans the possible MACs for wireless cameras. The adversary then performs motion to stimulate the camera. The app logs accelerometer readings for motion speed calculation. With observed traffic, the app outputs the current camera state and the consumed time, indicating completion of status determination. We tested 11 most popular wireless cameras, as shown in Table 1.

TABLE 1
Tested wireless security cameras

| | | Cloud Recording |
|---|---|---|
| Camera ID | Model | (Unpaid) |
| 1 | Arlo Pro 3 | No |
| 2 | Arlo Pro 4 | No |
| 3 | Arlo Ultra 2 | No |
| 4 | Blink XT2 | No |
| 5 | Blink Outdoor | No |
| 6 | Ring Stick Up Cam | No |
| 7 | Ring Spotlight | No |
| 8 | Reolink Argus 2 | No |
| 9 | SimpliSafe Cam | No |
| 10 | Wyze Battery Cam Pro | No |
| 11 | Wyze Cam Outdoor v2 | No |

Such camera models are selected from major brands sold online on Amazon and BestBuy. Non-paying cameras only have basic functions (live video streaming and event notification) while paying ones offer cloud recording capability. Two typical scenarios were considered, including one indoors, and one outdoors. In the indoor scenario, the camera was installed on the wall of a living room (of 372 square feet) to monitor the room (FIG. 10 (left)). In the outdoor scenario, the camera was mounted on the front outside wall (height: 10 feet; width: 17 feet) of a typical American single-family house to monitor the entryway into the house (FIG. 10 (right)). In each environment, the camera is deployed with its field of view unblocked by a wall or other obstacles and an adversary can thus feed motion stimuli to it.

Three evaluation metrics were used. The first was Success rate, defined as the ratio between the number of successful camera state inference attempts and the total number of inference trials. The second was F1 score, defined as the harmonic mean of precision and recall, with its best value at 1 and worst score at 0. The third was Detection time, defined as the amount of time spent on obtaining the camera state in terms of the subscription plan and live streaming mode.

### 2.2 Case Study

In this case, we let two Arlo Pro 3 cameras (one with and the other without a subscription) monitor the same area, as shown in FIG. 10 (left). The user determines that there exist wireless cameras monitoring the area, initiates motion in the area, and sniffs environmental wireless traffic. We tested the following three situations.

### 2.2.1 No Live Video is Streamed on Both Cameras:

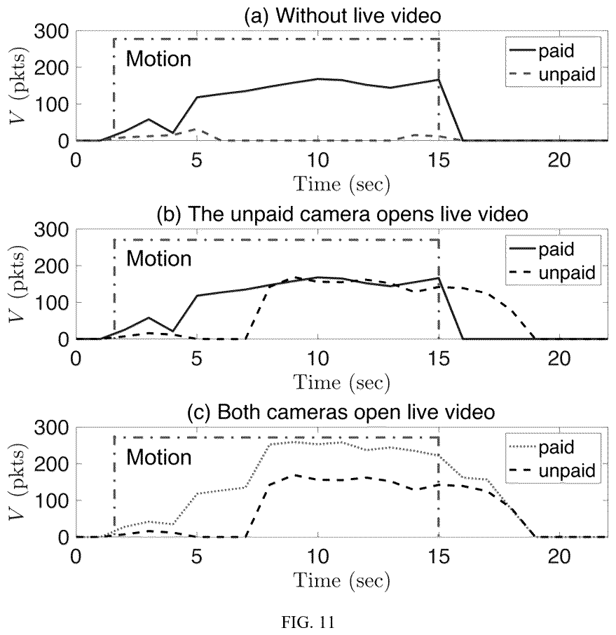

When the user does not notice the motion notification (e.g., the phone is muted), no live stream will be opened. FIG. 11(a) shows the traffic flow generated by the two cameras. We observe a strong correlation between the traffic volume (i.e., count of newly generated packets) with the motion for the paid camera, i.e., the volume matches with the newly performed motion. However, for the unpaid camera, there is only a small amount of traffic at the beginning of the motion, corresponding to the motion notification. The paid camera not only sends a notification but also records to the cloud until the motion ends. Furthermore, we see that the traffic volume for a motion notification of the paid camera is larger than that of the unpaid one. This is because, with a subscription, the push notification information is richer and includes a thumbnail image from the recorded video, which is not available for the unpaid camera.

### 2.2.2 Live Video is Streamed Only on the Unpaid Camera:

Just for the unpaid camera, we stream live video once receiving the motion notification. FIG. 11(b) compares the corresponding two traffic traces, and we see clear differences. First, unlike the paid camera, which automatically records after being activated by the motion, the unpaid one re-generates the traffic burst only after the live view is turned on (at the 8th second). To stream live video, we have to tap the notification or the app on the phone. Human reaction, tapping, and app login take time. There is thus an inevitable delay between detecting the motion and the start of the live video stream. Second, we may not end the live video exactly as the motion ends. We habitually watch until the motion ends and then close the app. Similarly, we need time to react and close the app. That is why we still observe traffic burst even after the motion ends for the unpaid camera. However, the paid camera ends recording (i.e., generating traffic bursts) precisely once the motion ends.

### 2.2.3 Live Video is Streamed on Both Cameras:

FIG. 11(c) shows the traffic volume of both cameras streaming live videos. Unlike the unpaid camera, the paid one generates high traffic volume immediately once the motion is detected. Also, when the motion lasts and the live video is on, the traffic volume for the paid camera is apparently higher than that for the unpaid one. This is due to the fact that the paid camera streams live video and uploads the recorded video to the cloud at the same time, while the unpaid camera only streams live video. These results convincingly verify that the two cameras' traffic traces in this situation are still distinguishable. By extracting features from the observed traffic flows, WeakCamID is able to successfully infer these camera states.

### 2.3 Impact of Motion Duration

Different durations of motion occurring within the motion detection area of the camera (with a subscription or in live view mode) may generate varying wireless traffic volumes. Accordingly, we vary the value of motion duration from 8 to 16 seconds, with increments of 2 seconds. For each value and camera state of every camera, we perform 10 trials and have 11×4×5×10=2,200 attempts in total.

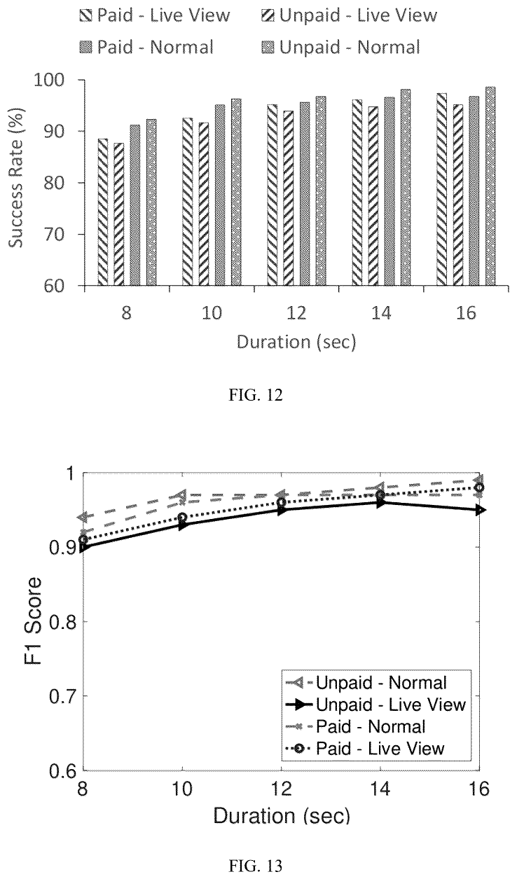

FIG. 12 shows the average success rates for different motion durations. We have the following observations. First, the success rate always maintains at a high level, i.e., ranging from 88% to 99%, regardless of motion duration and camera state. Second, with the duration increasing from 8 to 12 seconds, the success rate becomes larger. It then maintains a stable high value (above 94%) after the duration is longer than 12 seconds. Lastly, the unpaid camera in live view mode and the unpaid camera in normal mode consistently has the lowest and highest average success rates regardless of motion duration. This appears as the motion-induced traffic flows generated by unpaid cameras in live view and normal modes are the least and the most distinguishable, respectively. FIG. 13 presents the F1 scores for all varying motion durations. We see that the F1 score is always above 0.9, again indicating high inference accuracy.

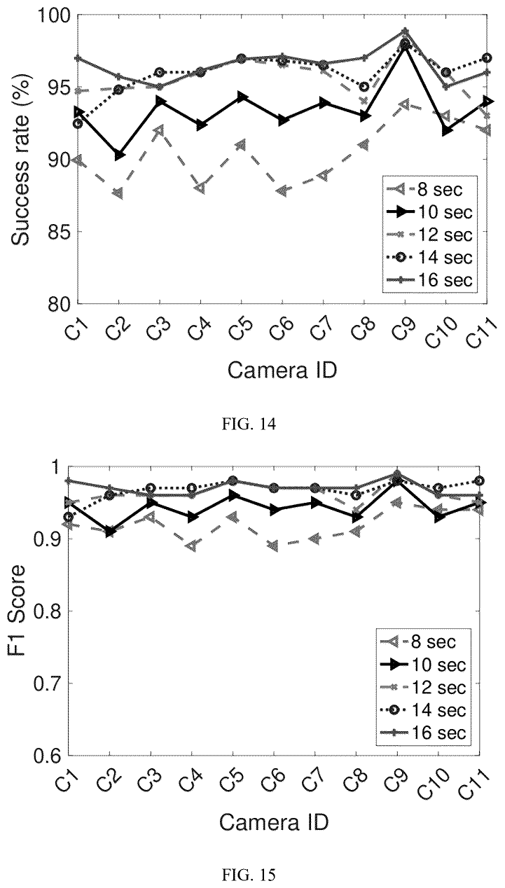

FIGS. 14 and 15 present the average success rates and F1 scores of all camera states for each camera with varying motion durations. We see that the success rates and F1 scores for all cameras are consistently high (with a minimum of 88% and 0.89), while C9 (SimpliSafe Cam) always has a higher success rate or F1 score than the rest. This appears because C9 uses differentiated video streaming quality for paid and unpaid cameras while others use the same quality for both types of cameras. The resolution of C9 is 1080p (1920×1080) with a subscription and decreases to just 480p (640×480) with no subscription. Such difference further enlarges the discrepancy between corresponding traffic volumes, facilitating camera state distinction. Also, we find for most cameras, the success rate or F1 score increases with the motion duration until the latter reaches 12 seconds, and remains relatively stable after that.

### 2.4 Impact of Movement Speed

The speed Um of motion occurring in the camera's detection range may affect its recording behavior. For example, if the speed is too slow, from the camera's perspective, the total motion may consist of multiple short activities. Compared with a quick motion which just triggers the camera once, such a slow one may cause the camera to be activated multiple times in a discontinuous way. We vary Um from 0.2 to 1.4 m/s, with increments of 0.2. The app logs accelerometer readings for calculating the speed. For each Um and camera state, we perform 100 attempts of WeakCamID to infer the state of the camera (Ring Stick Up Cam).

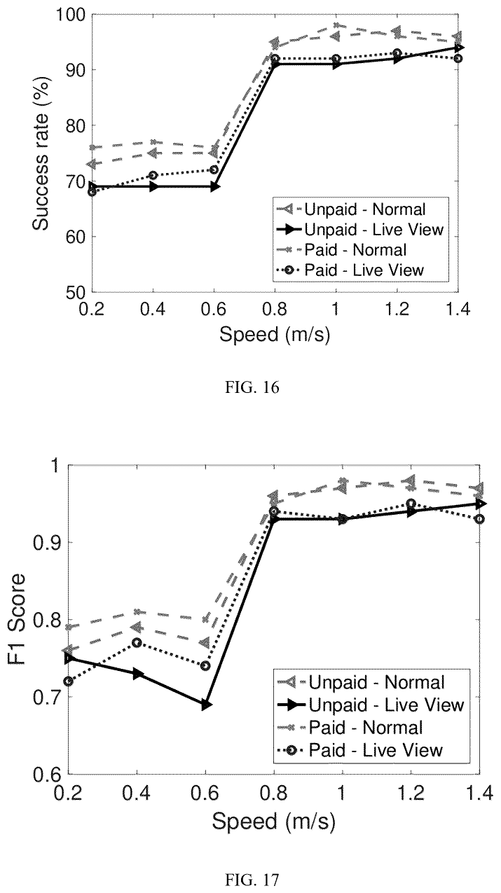

FIG. 16 illustrates the average success rates when vₘ varies. We observe that the success rate is below 77% when vₘ is no larger than 0.6 m/s. This is because the low speed may trigger the cameras multiple times and cause the camera to generate multiple notification alerts. The resultant traffic patterns become less discernible. Also, we see that once the walking speed reaches 0.8 m/s, the success rate can always be larger than 92%. Meanwhile, for the same speed, the corresponding success rates for normal mode are consistently higher than that for live view mode. Specifically, the average success rates for normal and live view modes are 96.0% and 92.5%. This appears due to the fact that the live view mode is controlled by the user, who may turn it on at a random time after receiving a motion alert, causing the traffic patterns associated with streaming live videos more diverse. FIG. 17 plots the corresponding F1 scores, which always exceed 0.93 when the speed reaches 0.8 m/s. Also, the F1 scores for the normal mode are higher than that for the live view mode. The range for normal walking speed is 1.2 to 1.4 m/s for adults. WeakCamID can thus achieve high accuracy without requiring an average user to change gait speed.

### 2.5 Impact of Previously Unknown Cameras

One concern is whether our system works for a new camera, whose brand/model is previously unknown. As aforementioned, most camera vendors take largely identical operating flows, causing their traffic variation quite consistent. WeakCamID can be thus applied to infer states of new cameras without retraining the model.

We specify one camera as the new camera and use the other ten (in Table 1) for training. Accordingly, we generate 11 traffic classifiers, referred to as Victim-exclusive. We then use each classifier to infer the state of the corresponding new camera 100 times, whose traffic data are not included in the training data set of this classifier. For comparison, we also investigate the performance of the classifier (called Victim-inclusive) that utilizes all 11 cameras for training and use it to infer the state of every camera 100 times.

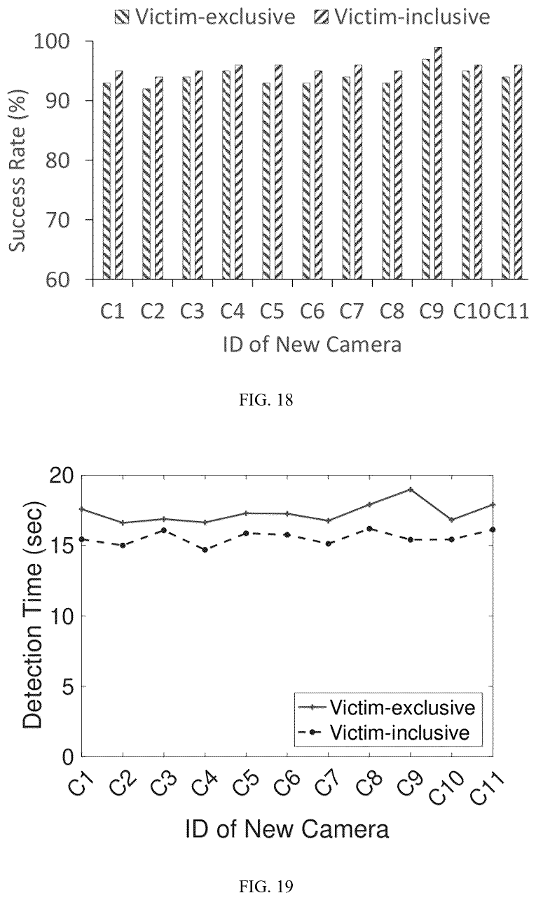

FIG. 18 presents the comparison of the success rates for applying Victim-inclusive and Victim-exclusive classifiers. We see that the Victim-inclusive classifier always performs slightly better than corresponding Victim-exclusive ones. Specifically, the mean success rate for all Victim-exclusive classifiers is 94.1% while the Victim-exclusive classifier achieves an average success rate of 95.8% across all cameras. FIG. 19 compares the average detection time. We observe that for each victim camera, the detection time obtained from the Victim-exclusive classifier, ranging from 16.6 to 18.9 seconds, is always slightly longer than that obtained from the Victim-inclusive classifier. The small increase in detection time comes from requiring a longer time for the corresponding Victim-exclusive classifier to process the data. These results show that WeakCamID works for new cameras with a high probability and within a short period.

### 2.6 Overall Inference Performance

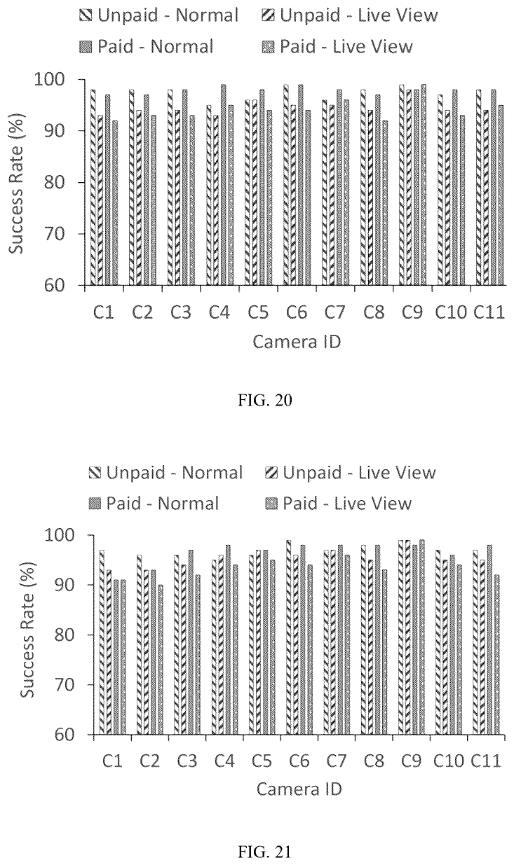

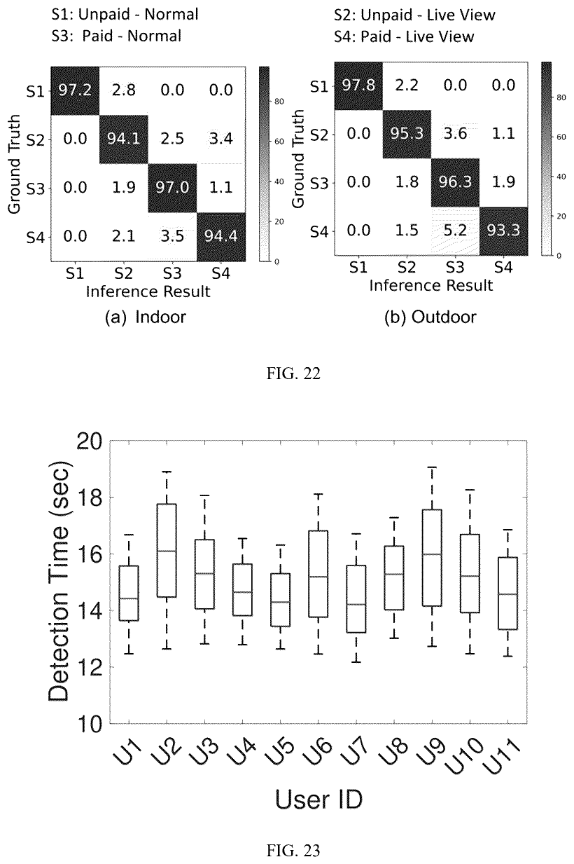

For each mode of every camera in Table 1, we perform 100 trials in each environment. Thus, we have 11×4×2×100=8,800 attempts in total. FIGS. 20 and 21 present the success rates for different cameras in the indoor and outdoor environments. We observe two major tendencies. First, the success rate is consistently high over different camera states and models, ranging from 92% to 99% and 90% to 99% for the indoor and outdoor environments, respectively. Particularly, for C9 (SimliSafe Cam) in both environments, our technique can detect all camera states with a success rate always above 98%. This again confirms that the recording quality differentiation strategy taken by C9 makes traffic flows more distinguishable. Second, a camera in normal mode can usually be detected with higher accuracy, especially when the camera has a subscription. This may be because cameras in live view mode generate higher traffic volume, causing the traffic flows to be misclassified more.

FIG. 22 plots confusion matrices of the inference results. We see that WeakCamID has consistently high true positive rates (93.3% or above) and low false positive rates (below 2.9%). We compute the F1 scores, which are both 0.96 on average for the indoor and outdoor environments. FIG. 23 plots the empirical CDFs of the detection time T_{indoor} and T_{outdoor} under the indoor and outdoor environments. We see no apparent difference in detection time for both environments. T_{indoor} and T_{outdoor} are less than 17.6 and 17.5 seconds with probability 95.0%. These results convincingly demonstrate that WeakCamID can effectively and efficiently infer camera states.

### 2.7 Multiple-Camera Scenario

In a multi-camera scenario, the adversary needs to infer the states of all cameras in order to determine whether there is a risk of being recorded when performing motion in the area. WeakCamID tracks the wireless traffic based on MAC addresses. It can monitor multiple camera-associated traffic flows at the same time. Different cameras have no interference with each other for camera state inference.

To evaluate WeakCamID on a multiple-camera scenario, we deploy varying numbers of cameras (1 to 6) in the testing room. We manually tweak the fields of view of the cameras and make them overlap partially. We perform WeakCamID for 50 attempts for each camera count. We randomly change the location and state of each camera at every attempt. As the inference error mainly comes from current wireless traffic patterns and varies with the duration of performed motion, it is thus quite consistent across coexisting cameras. We find that for each camera count from 2 to 6, WeakCamID always successfully infers the states of all cameras with a probability exceeding 94.5%, similar to what we achieve for inferring a single camera's state.

TABLE 2
Detection time vs. camera count.

| | Detection time (seconds) | | |
|---|---|---|---|
| Camera count | Average | Minimum | Maximum |
| 1 | 14.6 | 12.5 | 17.3 |
| 2 | 16.5 | 14.7 | 26.2 |
| 3 | 19.7 | 16.5 | 27.1 |
| 4 | 24.1 | 18.3 | 29.9 |
| 5 | 35.1 | 32.7 | 39.3 |
| 6 | 36.8 | 34.9 | 43.8 |

Table 2 presents the mean, minimum, and maximum detection time of successful trials for different numbers of cameras. We find that when the camera count is no more than 3, the detection time just slightly increases with the count in most cases. This is because the one-time motion (i.e., walking) triggers all cameras at the same time and WeakCamID can take advantage of it to infer the states of all cameras. Thus, an extra camera only adds data processing time. Also, we see that when the camera count exceeds 3, it is often not enough to walk one time to trigger all cameras, and we have to perform several movements instead. As a result, inferring the states of multiple cameras is equivalent to inferring the state of a single camera several times, and the detection time is almost proportional to the corresponding number of performing movements. Overall, WeakCamID can infer the states of up to 6 cameras within less than three-quarters of a minute, demonstrating the high efficiency of the proposed technique.

### 2.8 User Study

We recruited 11 volunteers (U1-U11; 5 self-identified as females and 6 as males) and asked each to perform WeakCamID to infer the state of a randomly selected camera deployed in the aforementioned indoor and outdoor environments. Every participant performed 50 attempts for each camera state under each environment, and thus 50×4×2=400 attempts in total. For each participant, the camera state appears in random order. Based on empirical results, we instructed the participants to introduce motion stimulation lasting 12 seconds or longer to achieve higher inference accuracy.

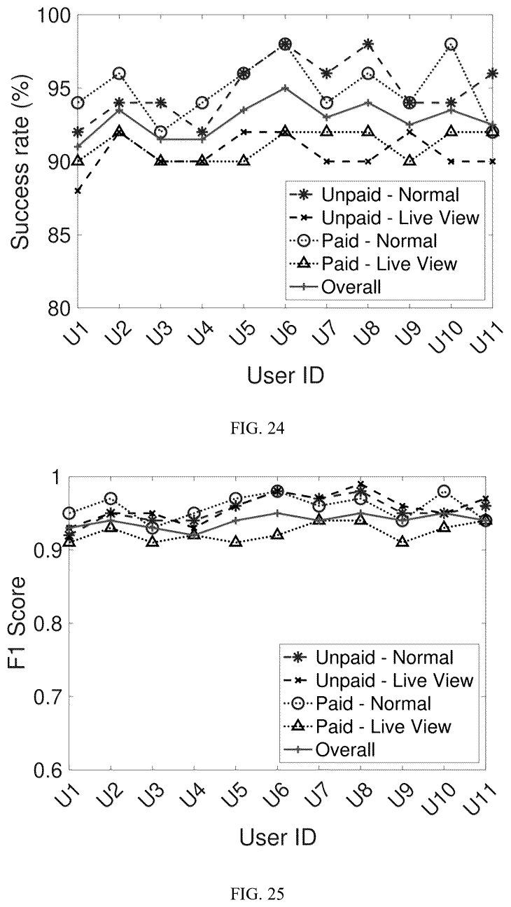

FIGS. 24 and 25 present the obtained success rates and F1 scores. We see that the average success rate and F1 score range from 91.0% to 95.0% and from 0.92 to 0.95, respectively. Also, regardless of the subscription status, the success rate or F1 score for the normal state is slightly higher than the live view mode. Specifically, the average success rates of the states Unpaid —Normal and Paid—Normal for all users are 95.0% and 94.9%, while that for the states Unpaid-Live View and Paid-Live View are just 90.8% and 91.1%. These results convincingly demonstrate that the performance of WeakCamID is robust to different camera states and users.

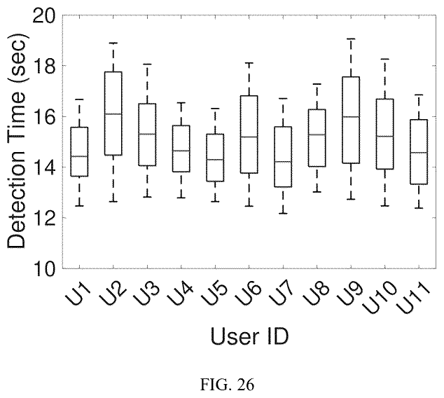

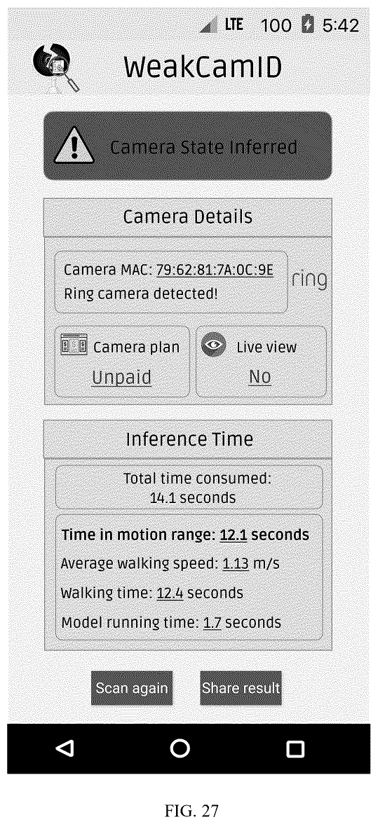

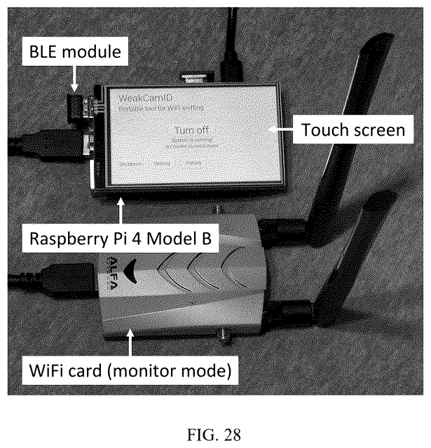

FIG. 26 plots the users' detection time. We observe a consistent average detection time for all users varying from 14.3 and 16.0 seconds, indicating that a user can generally identify the camera state within a short period. This verifies the practicality of WeakCamID. FIG. 27 exhibits the designed UI of the developed mobile app WeakCamID. A non-limiting embodiment of an external tool of the disclosed system for wifi sniffing comprises four components, as shown in FIG. 28. The four components include a BLE module for a phone connection, a touch screen for user interaction, a WiFi adapter card (e.g., RTL8814AU chipset) in monitor mode, and a Raspberry Pi 4 Model B acting as a platform for the previous three components.

In conclusion, the present disclosure is directed to a system and method (WeakCamID) for universal camera state inference. It is the first to point out the vulnerability of current wireless non-subscription security cameras. An adversary may bypass such a camera without being recorded via passive WiFi sniffing. WeakCamID can be realized with a single smartphone and requires neither professional equipment nor a connection to the same network as the target camera. It works by generating motion to stimulate the camera, and correlating the camera state (i.e., the statuses of subscription and live view mode) with the disclosed traffic pattern. A mobile app has been developed to implement WeakCamID. Extensive real-world experiments on top of the developed app and 11 popular wireless cameras verify the effectiveness and efficiency of WeakCamID.

### Embodiments

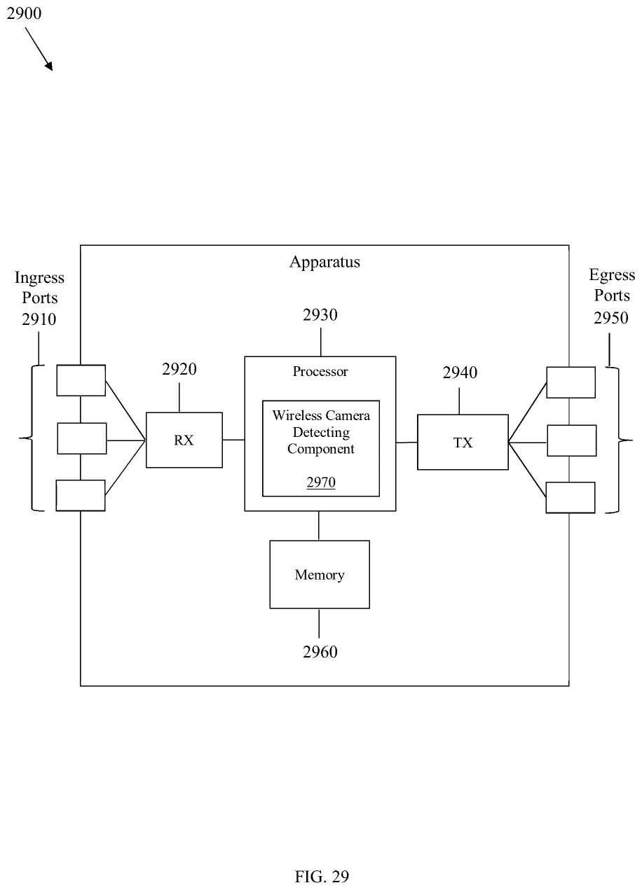

FIG. 29 is a schematic diagram of an apparatus 2900. The apparatus 2900 may implement the disclosed embodiments. The apparatus 2900 comprises ingress ports 2910 and an RX 2920 to receive data; a processor 2930, or logic unit, baseband unit, or CPU, to process the data; a TX 2940 and egress ports 2950 to transmit the data; and a memory 2960 to store the data. The apparatus 2900 may also comprise OE components, EO components, or RF components coupled to the ingress ports 2910, the RX 2920, the TX 2940, and the egress ports 2950 to provide ingress or egress of optical signals, electrical signals, or RF signals.

The processor 2930 is any combination of hardware, middleware, firmware, or software. The processor 2930 comprises any combination of one or more CPU chips, cores, FPGAs, ASICs, GPUs, or DSPs. The processor 2930 communicates with the ingress ports 2910, the RX 2920, the TX 2940, the egress ports 2950, and the memory 2960. The processor 2930 comprises a wireless camera detecting component 2970, which implements the disclosed embodiments. The inclusion of the wireless camera detecting component 2970 therefore provides a substantial improvement to the functionality of the apparatus 2900 and effects a transformation of the apparatus 2900 to a different state. Alternatively, the memory 2960 stores the wireless camera detecting component 2970 as instructions, and the processor 2930 executes those instructions.

The memory 2960 comprises any combination of disks, tape drives, or solid-state drives. The apparatus 2900 may use the memory 2960 as an overflow data storage device to store programs when the apparatus 2900 selects those programs for execution and to store instructions and data that the apparatus 2900 reads during execution of those programs. The memory 2960 may be volatile or non-volatile and may be any combination of ROM, RAM, TCAM, or SRAM.

A computer program product may comprise computer-executable instructions that are stored on a computer-readable medium and that, when executed by a processor, cause an apparatus to perform any of the embodiments. The computer-readable medium may be the memory 2960, the processor may be the processor 2930, and the apparatus may be the apparatus 2900.

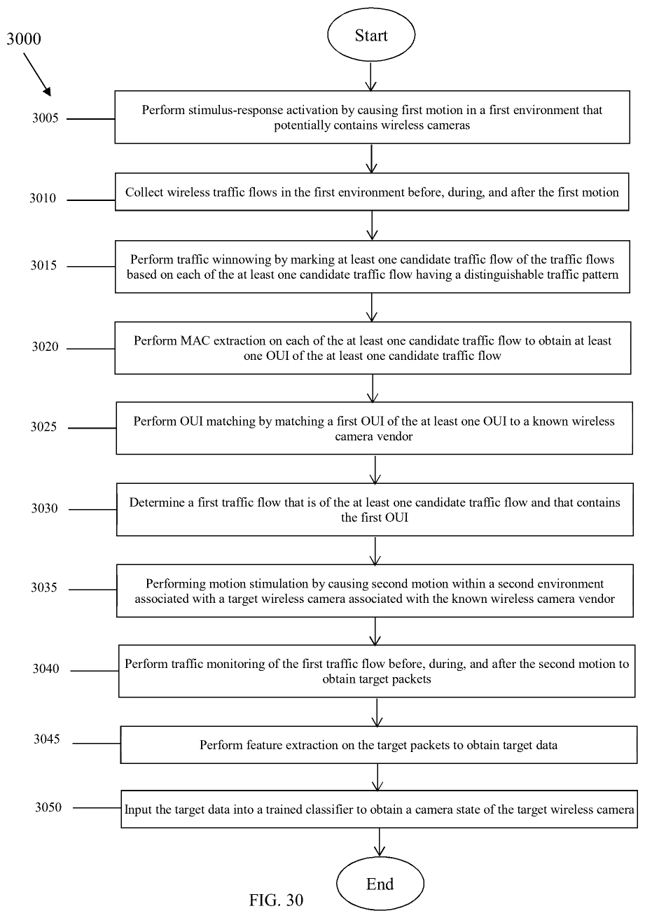

FIG. 30 is a flowchart of a method 3000 of detecting non-subscription security cameras. The apparatus 2900 or a combination of such apparatuses in a system may implement the method. At step 3005, stimulus-response activation is performed by causing first motion in a first environment that potentially contains wireless cameras. At step 3010, wireless traffic flows in the first environment are collected before, during, and after the first motion. At step 3015, traffic winnowing is performed by marking at least one candidate traffic flow of the traffic flows based on each of the at least one candidate traffic flow having a distinguishable traffic pattern. At step 3020, MAC extraction is performed on each of the at least one candidate traffic flow to obtain at least one OUI of the at least one candidate traffic flow. At step 3025, OUI matching is performed by matching a first OUI of the at least one OUI to a known wireless camera vendor. At step 3030, a first traffic flow that is of the at least one candidate traffic flow and that contains the first OUI is determined. At step 3035, motion stimulation is performed by causing second motion within a second environment associated with a target wireless camera associated with the known wireless camera vendor. At step 3040, traffic monitoring of the first traffic flow is performed before, during, and after the second motion to obtain target packets. At step 3045, feature extraction is performed on the target packets to obtain target data. At step 3050, the target data is inputted into a trained classifier to obtain a camera state of the target wireless camera. The camera state indicates whether the target wireless camera can save video and whether a live stream of the target wireless camera has been opened.

The method 3000 may implement additional embodiments. For instance, the distinguishable traffic pattern comprises a substantial increase in throughput when the first motion starts. The distinguishable traffic pattern further comprises a substantial decrease in the throughput when the first motion ends.

Performing the MAC extraction comprises extracting at least one header from the at least one candidate traffic flow. Each of the at least one header is unencrypted. Performing the MAC extraction further comprises extracting at least one MAC address from the at least one header. Each of the at least one MAC address is 48 bits. Performing the MAC extraction further comprises extracting the at least one OUI from the at least one MAC address. Each of the at least one OUI is the first 24 bits from a respective one of the at least one MAC address.

The method 3000 further comprises building the trained classifier by: performing data collection by collecting training-phase traffic flows from training-phase wireless cameras; performing training-phase feature extraction on the training-phase traffic flows to obtain feature vectors; performing state labelling by labeling camera states to obtain a training set; and performing traffic classifier building by performing supervised learning using the feature vectors and the training set to obtain the trained classifier.

Further to the above, although illustrative implementations of one or more embodiments have been provided herein, the disclosed systems and/or methods may be implemented using any number of techniques, whether or not they are currently known or in existence. The disclosed systems and methods might be embodied in many other specific forms without departing from the spirit or scope of the present disclosure. The disclosure should in no way be limited or restricted to the illustrative implementations, drawings, and techniques illustrated herein, including the exemplary designs and implementations illustrated and described herein, but may be modified within the scope of the appended non-limiting claims along with their full scope of equivalents. In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

In at least one non-limiting embodiment, what is claimed is a system and method for using a smartphone to remotely detect when a security camera is supported by a subscription to the cloud or is not supported by a subscription to the cloud, by generating a motion to stimulate the security camera and sniffing resultant wireless traffic to infer the state of the security camera.

What is claimed is:

1. A method comprising:
performing stimulus-response activation by causing first motion in a first environment that potentially contains wireless cameras;
collecting wireless traffic flows in the first environment before, during, and after the first motion;
performing traffic winnowing by marking at least one candidate traffic flow of the traffic flows based on each of the at least one candidate traffic flow having a distinguishable traffic pattern;
performing medium access control (MAC) extraction on each of the at least one candidate traffic flow to obtain at least one organizationally-unique identifier (OUI) of the at least one candidate traffic flow;
performing OUI matching by matching a first OUI of the at least one OUI to a known wireless camera vendor;
determining a first traffic flow that is of the at least one candidate traffic flow and that contains the first OUI;
performing motion stimulation by causing second motion within a second environment associated with a target wireless camera associated with the known wireless camera vendor;
performing traffic monitoring of the first traffic flow before, during, and after the second motion to obtain target packets;
performing feature extraction on the target packets to obtain target data; and
inputting the target data into a trained classifier to obtain a camera state of the target wireless camera,
wherein the camera state indicates whether the target wireless camera can save video and whether a live stream of the target wireless camera has been opened.

2. The method of claim 1, wherein the distinguishable traffic pattern comprises a substantial increase in throughput when the first motion starts.

3. The method of claim 2, wherein the distinguishable traffic pattern further comprises a substantial decrease in the throughput when the first motion ends.

4. The method of claim 1, wherein performing the MAC extraction comprises extracting at least one header from the at least one candidate traffic flow.

5. The method of claim 4, wherein each of the at least one header is unencrypted.

6. The method of claim 4, wherein performing the MAC extraction further comprises extracting at least one MAC address from the at least one header.

7. The method of claim 6, wherein each of the at least one MAC address is 48 bits.

8. The method of claim 6, wherein performing the MAC extraction further comprises extracting the at least one OUI from the at least one MAC address.

9. The method of claim 8, wherein each of the at least one OUI is the first 24 bits from a respective one of the at least one MAC address.

10. The method of claim 1, further comprising building the trained classifier by:
performing data collection by collecting training-phase traffic flows from training-phase wireless cameras;
performing training-phase feature extraction on the training-phase traffic flows to obtain feature vectors;
performing state labelling by labeling camera states to obtain a training set; and
performing traffic classifier building by performing supervised learning using the feature vectors and the training set to obtain the trained classifier.

11. A system comprising:
one or more memories configured to store instructions; and
one or more processors coupled to the one or more memories and configured to execute the instructions to cause the system to:
collect wireless traffic flows in a first environment that potentially contains wireless cameras before, during, and after first motion in the first environment;
perform traffic winnowing by marking at least one candidate traffic flow of the traffic flows based on each of the at least one candidate traffic flow having a distinguishable traffic pattern;
perform medium access control (MAC) extraction on each of the at least one candidate traffic flow to obtain at least one organizationally-unique identifier (OUI) of the at least one candidate traffic flow;
perform OUI matching by matching a first OUI of the at least one OUI to a known wireless camera vendor;
determine a first traffic flow that is of the at least one candidate traffic flow and that contains the first OUI;
perform traffic monitoring of the first traffic flow before, during, and after second motion to obtain target packets, wherein the second motion is within a second environment associated with a target wireless camera associated with the known wireless camera vendor;
perform feature extraction on the target packets to obtain target data; and
input the target data into a trained classifier to obtain a camera state of the target wireless camera,
wherein the camera state indicates whether the target wireless camera can save video and whether a live stream of the target wireless camera has been opened.

12. The system of claim 11, wherein the distinguishable traffic pattern comprises a substantial increase in throughput when the first motion starts.

13. The system of claim 12, wherein the distinguishable traffic pattern further comprises a substantial decrease in the throughput when the first motion ends.

14. The system of claim 11, wherein the one or more processors are further configured to execute the instructions to cause the system to further perform the MAC extraction by extracting at least one header from the at least one candidate traffic flow.

15. The system of claim 14, wherein each of the at least one header is unencrypted.

16. The system of claim 14, wherein the one or more processors are further configured to execute the instructions to cause the system to further perform the MAC extraction by extracting at least one MAC address from the at least one header.

17. The system of claim 16, wherein each of the at least one MAC address is 48 bits.

18. The system of claim 16, wherein the one or more processors are further configured to execute the instructions to cause the system to further perform the MAC extraction by extracting the at least one OUI from the at least one MAC address.

19. The system of claim 18, wherein each of the at least one OUI is the first 24 bits from a respective one of the at least one MAC address.

20. A computer program product comprising instructions that are stored on a computer-readable medium and that, when executed by one or more processors, cause a system to:
collect wireless traffic flows in a first environment that potentially contains wireless cameras before, during, and after first motion in the first environment;
perform traffic winnowing by marking at least one candidate traffic flow of the traffic flows based on each of the at least one candidate traffic flow having a distinguishable traffic pattern;
perform medium access control (MAC) extraction on each of the at least one candidate traffic flow to obtain at least one organizationally-unique identifier (OUI) of the at least one candidate traffic flow;
perform OUI matching by matching a first OUI of the at least one OUI to a known wireless camera vendor;
determine a first traffic flow that is of the at least one candidate traffic flow and that contains the first OUI;
perform traffic monitoring of the first traffic flow before, during, and after second motion to obtain target packets, wherein the second motion is within a second environment associated with a target wireless camera associated with the known wireless camera vendor;
perform feature extraction on the target packets to obtain target data; and
input the target data into a trained classifier to obtain a camera state of the target wireless camera,
wherein the camera state indicates whether the target wireless camera can save video and whether a live stream of the target wireless camera has been opened.
